(19) United States
(12) Patent Application Publication
(10) Pub. No.: US 2008/0040489 A1
(43) Pub. Date: Feb. 14, 2008

(54) METHOD OF ASSIGNING APPLICATIONS TO SPECIFIC NETWORK INTERFACES

(75) Inventors: Hugh E. Hockett, Raleigh, NC (US); Adam M. Gunther, Raleigh, NC (US); Eric Kirchstein, Raleigh, NC (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/456,220

(22) Filed: Jul. 10, 2006

(51) Int. Cl. G06F 15/16

(52) U.S. Cl. 709/228

(57) ABSTRACT

A method for assigning applications to specific network interfaces including initiating a computer application from a plurality of computer applications, requesting a socket for establishing a connection between the computer application and a network interface. Then connecting the computer application and the socket. Then prompting a user to visually select the network interface for the computer application from one of the following options, (i) user selects the specific network interface for the computer application, and (ii) user directs the operating system to select the best available network interface for the computer application. Then binding the socket to the network interface.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to computer applications, and more particularly, to a method for assigning computer applications to specific network interfaces.

2. Description of Background

Generally, people have the option of using either a wired or wireless Ethernet or both in order to provide access to a LAN. Wireless Ethernet is typically slower than wired Ethernet, especially when used for large downloads. Yet, if a user has a connection using wired Ethernet and the user disconnects to go to a meeting, the connection will be dropped (terminated). A user might want to have long-term low-bandwidth connections (e.g. telnet sessions) use wireless Ethernet and short-term high bandwidth connections (e.g. web browsing) use wired Ethernet.

Thus, there is a need for a solution that allows a user the option of being able to selectively associate applications with wireless Ethernet (e.g. telnet sessions) and associate other applications with permanent wired Ethernet connection (e.g. web browsers). This allows the user to maintain a network connection for certain applications even if the user disconnects their computer from the wired connection (e.g., the individual leaves their office for a meeting).

### SUMMARY OF THE INVENTION

The shortcomings of the prior art are overcome and additional advantages are provided through the provision of a method for assigning applications to specific network interfaces, comprising initiating a computer application from a plurality of computer applications. The next step of the method involves requesting a socket for establishing a connection between the computer application and a network interface. Then connecting the computer application and the socket. Then prompting a user to visually select a network interface for the computer application from one of the following options, (i) user selects the specific network interface for the computer application, and (ii) user directs the operating system to select the best available network interface for the computer application. The method concludes with binding the socket to the selected network interface.

Additional features and advantages are realized through the techniques of the proposed invention. Other embodiments and aspects of the invention are described in detail herein and are considered a part of the claimed invention. For a better understanding of the invention with advantages and features, refer to the description and to the drawing.

### TECHNICAL EFFECTS

As a result of the summarized invention, technically we have achieved a solution for a method for assigning applications to specific network interfaces.

### BRIEF DESCRIPTION OF THE DRAWING

The subject matter regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a flowchart of a method for assigning applications to specific network interfaces; and

FIG. 2 illustrates one example of a visual prompt, in accordance with an embodiment of the present invention.

The detailed description explains the preferred embodiments of the invention, together with advantages and features, by way of example with reference to the drawing.

### DETAILED DESCRIPTION OF THE INVENTION

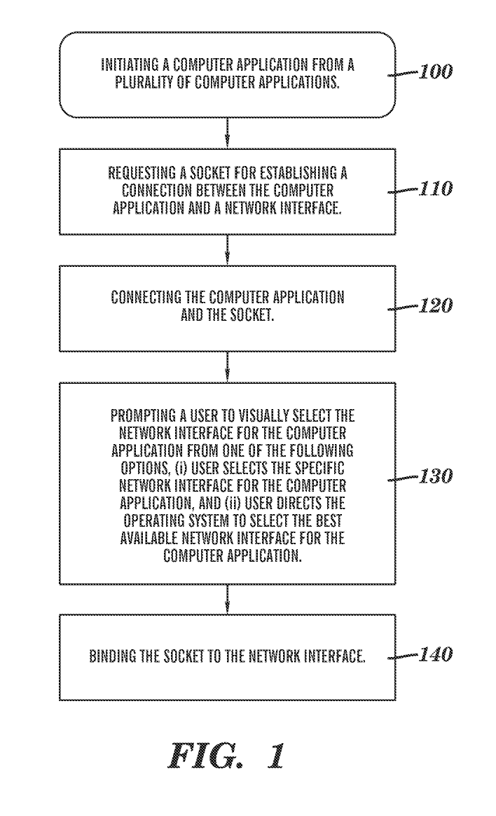

Referring to FIG. 1, a method for assigning applications to specific network interfaces in accordance with an exemplary embodiment will now be explained.

Starting at step 100, a computer user initiates a computer application by selecting the computer application from a plurality of computer applications that are loaded and stored on the user's computer.

At step 110, the initiated computer application sends a request to the microprocessor, the computer application requests a socket. The sockets are the communication links used to establish communication between the computer application and a network interface (wired or non-wireless network connection). Although, the computer application requested a socket to establish a communication link between the computer application and the network interface, the computer application does not bind to a specific IP address and network interface.

At step 120, a connection is established between the computer application and the socket. Once this connection occurs, the user is visually prompted at step 130 to select the network interface for the computer application to bind to from one of the following options; (i) user selects the specific network interface for the computer application, and alternatively, (ii) user directs the operating system to select the best available network interface for the computer application. Each interface possesses its own IP address.

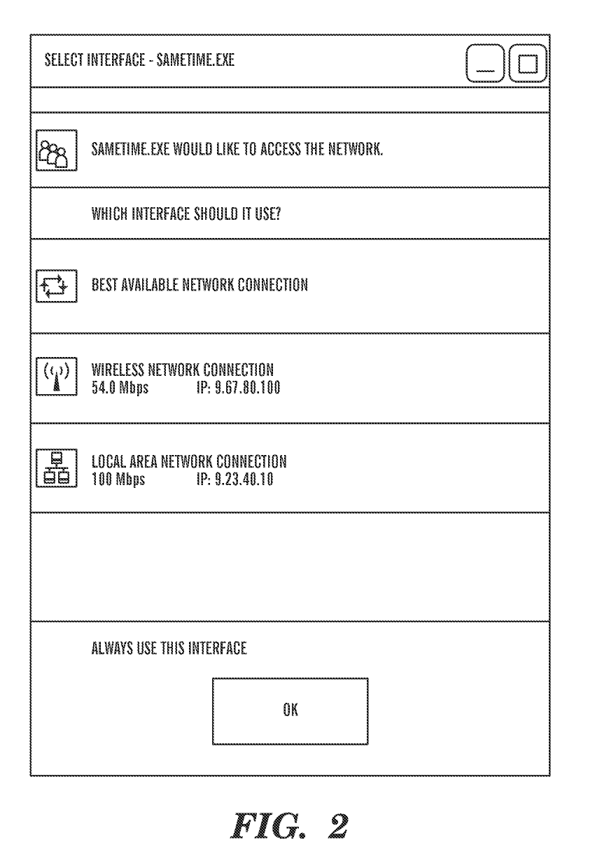

Provided that the user selects option (i), the user shall be visually prompted on the computer display to select a wireless or a non-wireless network interface connection. Referring to FIG. 2, an illustration of one example of a visual prompt is shown.

The method concludes at step 140 when the socket and the network interface are bound together. As shown, the disclosed method allows the user to assign the computer application by way of its connection with the socket to the specific network interface chosen by the user.

The socket and network interface binding connection may be saved by the user for future connections. If saved by the user, when the chosen computer application is re-initiated at a later time the computer application will automatically bind to the network interface that was previously selected by the user. The user may change the saved socket and network interface binding connection at anytime.

Embodiments of the invention allow a user to specify a network connection for each application so that a connection is maintained, even if the user disconnects from a wired network connection. This allows a user to maintain a connection over the wireless network (e.g., telnet session) if the user leaves their office and disconnects their computer from the wired network connection.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for assigning applications to specific network interfaces, comprising:
initiating a computer application from a plurality of computer applications;
requesting a socket for establishing a connection between the computer application and a network interface;
connecting the application and the socket;
prompting a user to visually select the network interface for the computer application from one of the following options, (i) user selects the specific network interface for the computer application, and (ii) user directs the operating system to select the best available network interface for the computer application; and
binding the socket to the network interface.

2. The method of claim 1, wherein option (i) includes a non-wireless and a wireless network interface connection for the user to select.

3. The method of claim 2, wherein the socket and network interface binding may be saved by the user for future connections, such that when the computer application is initiated the computer application will automatically bind to the network interface that was previously selected.

4. The method of claim 3, wherein the saved socket and network interface binding is changeable by the user at anytime.
